(19) United States
(12) Patent Application Publication
(10) Pub. No.: US 2014/0362035 A1
(43) Pub. Date: Dec. 11, 2014

(54) CAPACITIVE TOUCH SCREEN

(71) Applicant: FocalTech Systems, Ltd., Grand Cayman (KY)

(72) Inventors: Lianghua MO, Guangdong (CN); Chen LI, Guangdong (CN)

(73) Assignee: FocalTech Systems, Ltd., Grand Cayman (KY)

(21) Appl. No.: 14/085,461

(22) Filed: Nov. 20, 2013

(30) Foreign Application Priority Data
Jun. 6, 2013 (CN) 201310224090.8

(51) Int. Cl. G06F 3/044

(52) U.S. Cl. CPC G06F 3/044
USPC 345/174

(57) ABSTRACT

A capacitive touch screen, includes: a substrate; a plurality of sensing electrodes provided on the substrate, the plurality of sensing electrodes being arranged in a two-dimensional array; and a touch control chip bound to the substrate, the touch control chip being connected with each of the plurality of sensing electrodes via a corresponding wire. The touch control chip includes a driving source, a detection circuit and a timing control circuit, and each of the sensing electrodes is connected with the driving source and the detection circuit. The timing control circuit starts or cuts off the driving source according to a preset control scheme, and the detection circuit detects the change of the capacitance of each of the sensing electrodes to detect a touch position of a touch body on the touch screen.

### CROSS REFERENCE TO RELATED APPLICATION

This application claims priority to Chinese patent application No. 201310224090.8 titled “Capacitive Touch Screen” filed with the State Intellectual Property Office of PRC on Jun. 6, 2013, which is incorporated herein by reference in its entirety.

### BACKGROUND

1. Field of the Disclosure

The present disclosure relates to the field of touch control technique, and particularly to a capacitive touch screen.

2. Background of the Technology

At present, the touch screen is widely applied to various electronic products such as mobile phone, Personal Digital Assistant (PDA), Global Positioning System (GPS), computer, TV, etc., and has gradually penetrated into various fields of people's life and work. However, the current touch screen only supports a touch application using one active pen, and does not support an application simultaneously using multiple active pens.

### SUMMARY

Embodiments of the invention provide a capacitive touch screen that can detect positions of multiple touch points simultaneously and support the application using multiple active pens.

The capacitive touch screen provided by embodiments of the invention includes:

a substrate; a plurality of sensing electrodes provided on the substrate, the plurality of sensing electrodes being arranged in a two-dimensional array; and a touch control chip bound to the substrate, the touch control chip being connected with each of the plurality of sensing electrodes via a corresponding wire, wherein

the touch control chip includes a driving source, a detection circuit and a timing control circuit, and each of the plurality of sensing electrodes is connected with the driving source and the detection circuit; and

the timing control circuit starts or cuts off the driving source according to a preset control scheme, and the detection circuit detects a change of capacitance of each of the plurality of sensing electrodes to detect a touch position of a touch body on the touch screen.

Preferably, when the timing control circuit starts the driving source according to the preset control scheme, the detection circuit detects a change of self-capacitance of each of the plurality of sensing electrodes to detect a touch position of a passive touch body on the touch screen.

Preferably, when the timing control circuit cuts off the driving source according to the preset control scheme, the detection circuit detects a change of mutual-capacitance of each of the plurality of sensing electrodes to detect a touch position of an active touch body on the touch screen.

Preferably, the timing control circuit controls the driving source to start the plurality of sensing electrodes simultaneously or group by group, so that the detection circuit detects the plurality of sensing electrodes simultaneously or group by group.

Preferably, the detection circuit is not synchronized with an electric signal transmitted by the active touch body.

Preferably, the detection circuit is kept synchronized with an electric signal transmitted by the active touch body.

Preferably, the detection circuit is adjusted to be synchronized with an electric signal transmitted by the active touch body by means of a synchronization code transmitted by the active touch body.

Preferably, the detection circuit adjusts its phase, so that when an amplitude of an electric signal received by the detection circuit is maximum, synchronization with the electric signal transmitted by the active touch body is achieved, and the detection circuit is kept synchronized with the electric signal transmitted by the active touch body under the adjusted phase.

Preferably, each sensing electrode has at least one driving frequency.

Preferably, the plurality of sensing electrodes belong to at least more than one sensing electrode region, and the number of the touch control chips is the same as the number of the sensing electrode regions, and each touch control chip is connected with each sensing electrode in the sensing electrode region under a control of the touch control chip via a wire.

Preferably, the clocks of the touch control chips are synchronous or asynchronous.

Preferably, the sensing electrode is in a shape of at least one of a rectangle, a diamond, a circle and an ellipse.

Preferably, the substrate is a glass substrate, and the touch control chip is bound to the substrate in a chip-on-glass way; or

the substrate is a flexible substrate, and the touch control chip is bound to the substrate in a chip-on-film way; or

the substrate is a printed circuit board, and the touch control chip is bound to the substrate in a chip-on-board way.

According to the capacitive touch screen disclosed by the embodiments of the invention, the sensing electrodes are independent of each other, and the touch control chip is connected with each of the sensing electrodes via a wire, the touch control chip can accurately detect the positions of multiple touch points simultaneously touching on the touch screen according to a change rate of the capacitance of each of the sensing electrodes, thereby solving the problem in the prior art that the multi-point detection can not be performed accurately.

### BRIEF DESCRIPTION OF THE DRAWINGS

To illustrate a technical solution of the embodiments of the invention more clearly, the drawings required to be used in the description of the embodiments are simply introduced hereinafter. Apparently, the drawings described below are just several embodiments of the invention. To those skilled in the art, other drawings can be obtained according to these drawings without creative efforts.

FIG. 1 is a schematic diagram of a capacitive touch screen provided by an embodiment of the invention;

FIG. 2 is a top view of a sensing electrode array according to an embodiment of the invention;

FIG. 3 shows a sensing electrode driving method according to an embodiment of the invention;

FIG. 4A shows a sensing electrode driving method according to an embodiment of the invention;

FIG. 4B shows a sensing electrode driving method according to an embodiment of the invention;

FIG. 4C shows a sensing electrode driving method according to an embodiment of the invention;

FIG. 5 shows a sensing electrode driving method according to an embodiment of the invention;

FIG. 6 shows a sensing electrode driving method according to an embodiment of the invention;

FIG. 7 shows a signal synchronization diagram according to an embodiment of the invention;

FIG. 8 shows a multi-pen detection diagram according to an embodiment of the invention; and

FIG. 9 shows a signal flow graph of a touch control chip according to an embodiment of the invention.

### DETAILED DESCRIPTION

Embodiments of the invention provide a capacitive touch screen that can detect the positions of multiple touch points simultaneously.

To make the objects, features and advantages of the disclosure more clear and easy to be understood, the technical solutions of the embodiments of the disclosure are illustrated hereinafter in conjunction with the drawings in the embodiments of the disclosure. Apparently, the described embodiments are just a part of the embodiments of the invention. Based on the embodiments of the disclosure, any other embodiments obtained by those skilled in the art without creative efforts should fall within the scope of protection of the disclosure. For ease of illustration, sectional views showing the structure are enlarged partially rather than using an usual scale, and the views are only examples, which should not be understood as limiting the protection scope of the application. Furthermore, in an actual manufacture process, three-dimensioned space sizes, i.e. length, width and depth should be included.

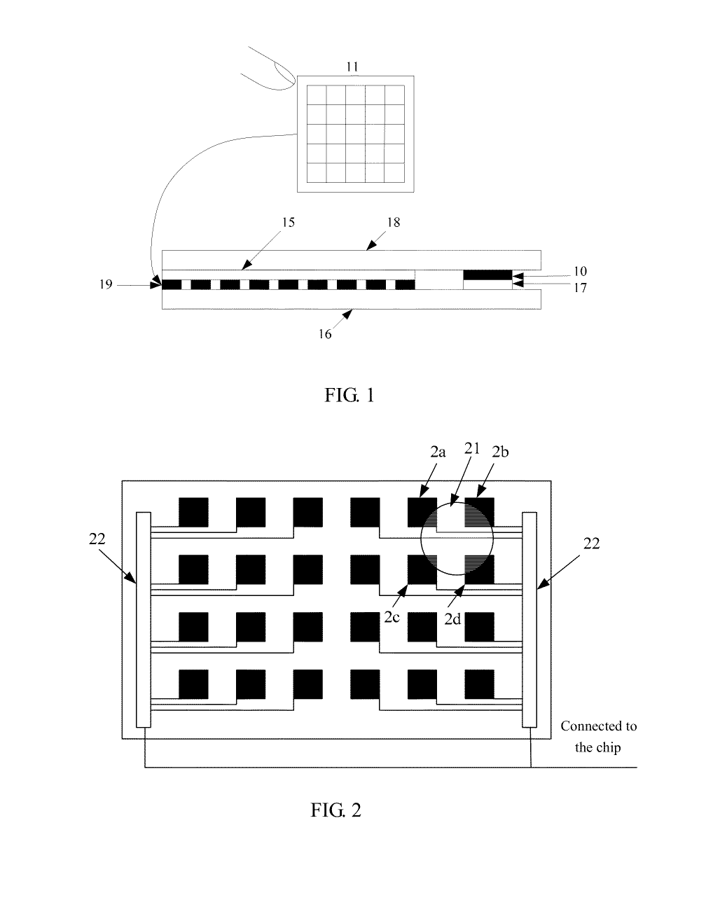

FIG. 1 is a schematic diagram of a capacitive touch screen provided by an embodiment of the invention. As shown in FIG. 1, the capacitive touch screen includes: a substrate 16; a plurality of sensing electrodes 19 provided on the substrate, the plurality of sensing electrodes 19 being arranged in a two-dimensional array; and a touch control chip 10 bound to the substrate 16, the touch control chip 10 being connected with each of the plurality of sensing electrodes 19 via a corresponding wire. The touch control chip 10 includes a driving source, a detection circuit and a timing control circuit (not shown in FIG. 1), and each of the sensing electrodes 19 is connected with the driving source and the detection circuit. The timing control circuit starts or cuts off the driving source according to a preset control scheme. The detection circuit detects a change of the capacitance of each of the sensing electrodes 19 to detect the touch position of a touch body on the touch screen.

The preset control scheme may be a sequence for starting and cutting off the driving source, the driving source may be firstly started, or may be firstly cut off.

The substrate 16 can be transparent, for example it may be a glass substrate or a flexible substrate; or the substrate 16 can also be non-transparent, for example it may be a printed circuit board. A plurality of sensing electrodes 19 are provided on the substrate 16, and the plurality of sensing electrodes 19 are arranged in a two-dimensional array which can be a rectangular array or a two-dimensional array with any other shapes. For the capacitive touch screen, each sensing electrode 19 is a capacitive sensor, the capacitance of which changes when a corresponding position on the touch screen is touched.

Optionally, a cover lens is provided above the sensing electrodes 19 to protect the sensing electrodes 19.

Each of the sensing electrodes 19 is connected to the touch control chip 10 via a wire, and the touch control chip 10 is bound to the substrate 16. Due to being connected with each of the sensing electrodes 19 via a wire, the touch control chip 10 has many pins, therefore, the difficulties of conventional packaging can be avoided by bonding the touch control chip 10 to the substrate 16. Specifically, the touch control chip 10 can be bound to the substrate 16 in a Chip-on-Glass (COG for short) way or a Chip-on-Film (COF for short) way or a Chip-on-Board (COB for short) way. According to the embodiments, an anisotropic conductive film (ACF) 17 can be provided between the touch control chip 10 and the substrate 16.

Moreover, the connection of the conventional flexible printed circuit board (FPC) requires reserving space for the touch control chip and FPC in hardware, which is not beneficial to simplicity of the system. However, by the COG way or COF way, the touch control chip and the touch screen are integrated, thereby significantly reducing the distance between them, and thereby reducing the whole volume. Moreover, since the sensing electrode is generally formed by etching indium tin oxide (ITO) on the substrate, and the touch control chip is also on the substrate, therefore the line connecting the sensing electrode and the touch control chip can be done in one ITO etching process, thereby significantly simplifying the manufacturing process.

FIG. 2 is a top view of a sensing electrode array according to an embodiment of the disclosure. Those skilled in the art should understand that, only one arrangement way of the sensing electrode is shown in FIG. 2, however in specific implementation, the sensing electrodes can be arranged in any two-dimensional array. Moreover, the spacing between the sensing electrodes in any direction can be equal or unequal. Those skilled in the art should also understand that, the number of the sensing electrodes can be more than the number shown in FIG. 2.

Those skilled in the art should understand that, only one shape of the sensing electrode is shown in FIG. 2. According to other embodiments, the sensing electrode can be in a shape of a rectangle, a diamond, a circle or an ellipse, or can also be in an irregular shape. The pattern of the sensing electrodes can be identical or not. For example, the sensing electrodes located in the central area uses a diamond structure, and the sensing electrodes located on edges uses a triangle structure. Moreover, the size of the sensing electrodes can be identical or not. For example, the size of the sensing electrodes near the inside is relatively large, and the size of the sensing electrodes near the edge is relatively small, which is beneficial for routing and the touch precision of edges.

Each of the sensing electrodes has a wire which is stretched out, and the wire is arranged in the space between the sensing electrodes. Generally, the wire is made as uniform as possible, and the routing is made as short as possible. Moreover, the routing range of the wires is made as narrow as possible on the premise of ensuring safe distance, thereby reserving more area for the sensing electrodes to enable more accurate sensing.

Each of the sensing electrodes can be connected to a bus 22 via a wire, and the wires are connected directly with the pins of the touch control chip via the bus 22 or connected with the pins of the touch control chip via the bus 22 after being sorted. For the touch screen of a large screen, the number of the sensing electrodes may be very large. In this case, a single touch control chip can be used to control all the sensing electrodes; or the screen is divided into several regions, and a plurality of touch control chips are used to respectively control the sensing electrodes in different regions, and clock synchronization can be kept between the plurality of touch control chips. At this time, the bus 22 can be divided into several bus sets for connecting with different touch control chips. Each of the touch control chips controls a same number of sensing electrodes, or controls a different number of sensing electrodes.

For the sensing electrode array shown in FIG. 2, the routing can be achieved in the same layer with the sensing electrode array. For the sensing electrode array with other structures, if routing in the same layer is difficult to achieve, the wire can also be arranged in another layer different from the layer where the sensing electrode array is located, and the wire is connected with the sensing electrode via a via hole.

There are two schemes to detect the position of a touch body on the touch screen, one is a self-capacitance detection scheme, and the other is a mutual-capacitance detection scheme.

The sensing electrode array shown in FIG. 2 is based on a touch detection principle of self-capacitance. Each sensing electrode corresponds to a specific position on the screen. In FIG. 2, 2a-2d represents different sensing electrodes. 21 represents a touch, and when a touch occurs at a position corresponding to a certain sensing electrode, charge on this sensing electrode changes, thereby whether a touch event occurs on the sensing electrode can be known by detecting the charge (current or voltage) on this sensing electrode. Generally, this can be achieved by converting an analog quantity into a digital quantity by an Analog-to-Digital Converter (ADC). The change of charge relates to the covered area of the sensing electrode, for example, the charge change of the sensing electrodes 2b and 2d are more than the charge change of the sensing electrodes 2a and 2c in FIG. 2.

Each position on the screen has a corresponding sensing electrode, and no physical connection exists between the sensing electrodes, therefore the capacitive touch screen provided by the embodiments of the disclosure can achieve a true Multi-Touch, thereby avoiding the problem of ghost point in the self-capacitance detection in the prior art.

The sensing electrode layer can be combined with a display screen by a surface sticking way; or the sensing electrode layer can be manufactured inside the display screen, such as an In-Cell touch screen; or the sensing electrode layer can be manufactured on the upper surface of the display screen, such as an On-Cell touch screen.

In the embodiments of the invention, the passive touch body can include a finger or other passive pens etc, and the active touch body can include active pens etc.

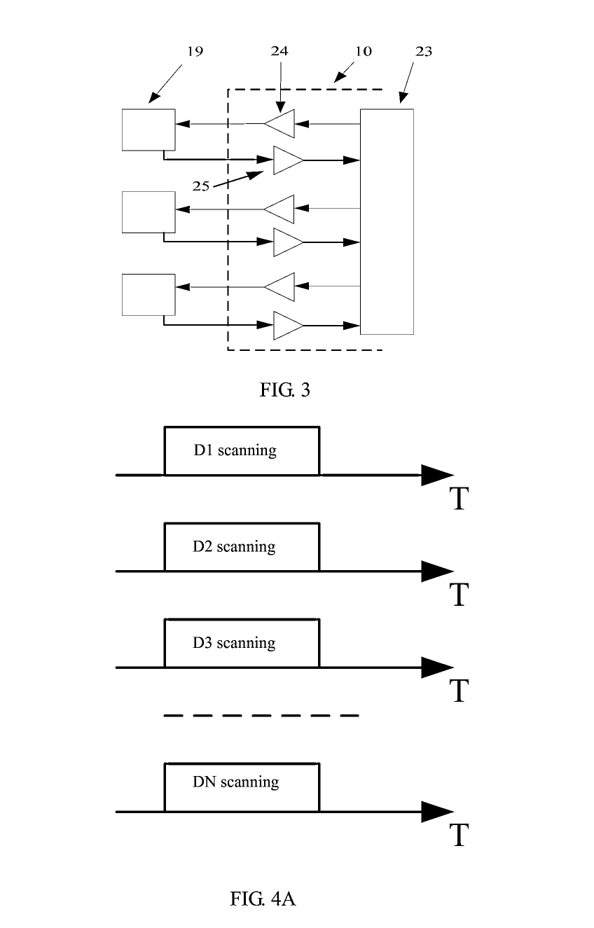

FIG. 3 shows a schematic diagram of a self-capacitance detection in this embodiment, in which, the touch control chip 10 includes a driving source 24, a detection circuit 25 and a timing control circuit 23, the sensing electrode 19 are connected with the driving source 24 and the detection circuit 25; when the timing control circuit 23 starts the driving source 24 according to a preset control scheme, the detection circuit 25 detects the change of self-capacitance of each sensing electrode 19 to detect the touch position of a passive touch body on the touch screen 11.

The timing control circuit 23 controls the operation timing of the driving sources 24 and the detection circuit 25. There are multiple choices for the driving timing of the sensing electrodes 19. The timing control circuit 23 controls the driving sources 24 to start the sensing electrodes 19 simultaneously or group by group, so that the detection circuit 25 detects the sensing electrodes 19 simultaneously or group by group.

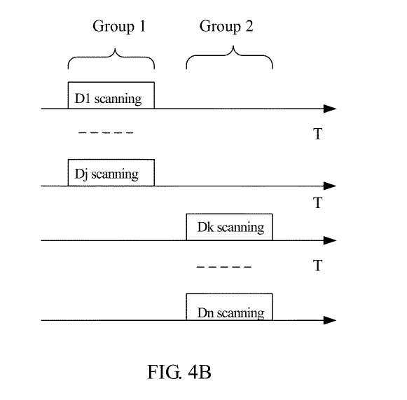

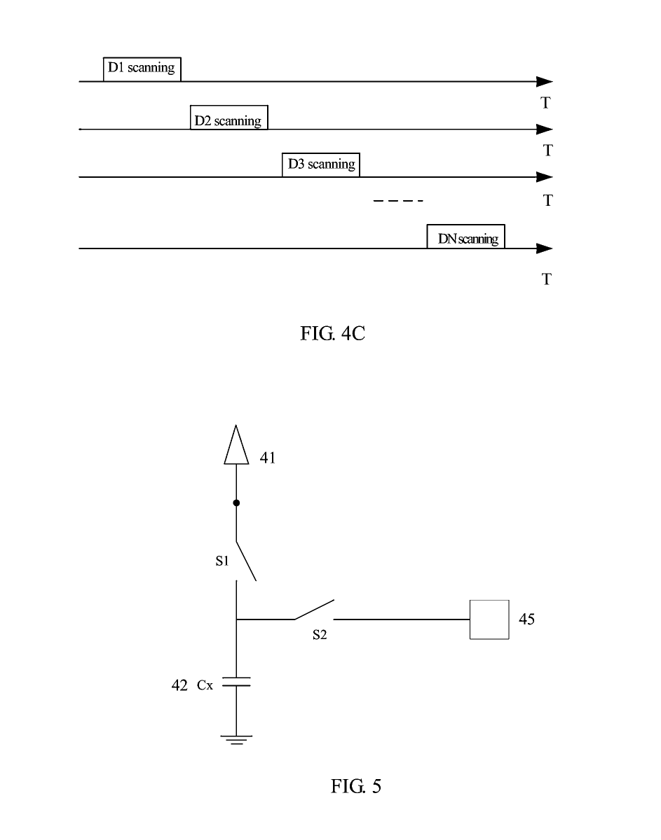

As shown in FIG. 4A, all the sensing electrodes are simultaneously driven and simultaneously detected. By this way, the time for finishing one scan is the shortest, and the number of the driving sources is the most (identical with the number of the sensing electrodes). As shown in FIG. 4B, the driving sources of the sensing electrodes are divided into several groups, and each group drives electrodes in a specific region in sequence. This way can achieve multiplexing of the driving sources, but the scanning time is increased, however, by choosing a proper number of groups, the multiplexing of the driving sources and the scanning time can reach a compromise.

FIG. 4C shows a scanning way of conventional mutual-capacitance touch detection. Assumed that there are N driving channels (TX), and the scanning time for each TX is Ts, then the time for scanning one frame is N*Ts. However, by using the sensing electrode driving method of the embodiment, all the sensing electrodes can be simultaneously detected, and the shortest time for scanning one frame is Ts. That is to say, compared with the conventional mutual-capacitance touch detection, the scanning frequency can be increased by N times by using the scheme of the embodiment.

For a mutual-capacitance touch screen with 40 driving channels, if the scanning time for each driving channel is 500 us, then the scanning time for a whole touch screen (one frame) is 20 ms, i.e. the frame rate is 50 Hz. Generally, 50 Hz can not achieve the requirements for a good experience. The scheme of the embodiments of the disclosure can solve this problem. By using the sensing electrodes arranged in a two-dimensional array, all the sensing electrodes can be detected simultaneously, and in the case that the detection time for each sensing electrode maintains 500 us, the frame rate reaches 2000 Hz. This greatly exceeds the application requirements of most touch screens. The redundant scan data can be used for such as anti-interference or touch track optimization by a digital signal processing terminal, thereby obtaining a better effect.

In-Cell touch screen performs scanning by using a field blanking time for each frame. However, the field blanking time for each frame is only 2-4 ms, and the conventional scanning time based on mutual-capacitance often reaches 5 ms or even more. In order to achieve a usage of the In-Cell screen, generally reducing the scanning time for mutual-capacitance detection, specifically, reducing the scanning time for each channel, this method reduces the signal-to-noise ratio (SNR) of the In-Cell screen, and affects the touch experience. The scheme of the embodiments of the disclosure can solve this problem. For example, for an In-Cell screen with 10 driving channels and a conventional mutual-capacitance touch detection scanning time of 4 ms, the scanning time for each channel is only 400 us. By using the scheme of the embodiments of the disclosure, all the electrodes are simultaneously driven and detected, and the time for scanning all the electrodes once is only 400 us. Comparing with the In-Cell panel described above having the scanning time for touch detection of 4 ms, there is a lot of time remained. The saved time can be used for multiple repeated detections or variable frequency detections and other detections, thereby greatly improving the SNR and anti-interference capability of detection signal, thereby obtaining a better effect.

Preferably, the self-capacitance of each of the sensing electrodes is detected. The self-capacitance of the sensing electrode can be an earth capacitance of the sensing electrode.

As an example, a charge detection method can be used. As shown in FIG. 5, the driving source 41 provides a constant voltage V1. The voltage V1 can be a positive voltage, a negative voltage or the earth. S1 and S2 represent two controlled switches, 42 represents an earth capacitance of the sensing electrode, 45 represents a charge receiver module, and the charge receiver module 45 can clamp the input voltage to a specified value V2 and measure the quantity of the input or output charge. At first, S1 is closed and S2 is open, and the upper plate of Cx is charged to the voltage V1 provided by the driving source 41; then S1 is open and S2 is closed, and Cx exchanges charge with the charge receiver module 45. Assumed that charge transfer quantity is Q1, then the voltage of the upper plate of Cx changes to V2, then from C=Q/ΔV, Cx=Q1/(V2−V1) is obtained, thereby capacitance detection is achieved.

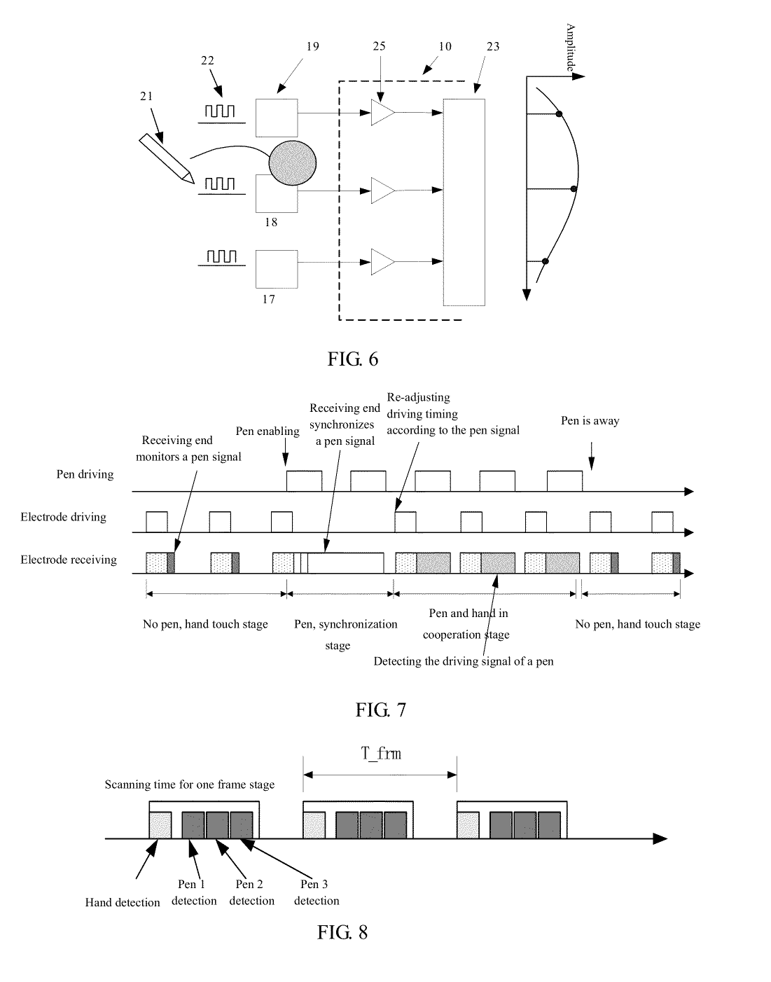

FIG. 6 shows a schematic diagram of the mutual-capacitance detection in the embodiment, in which, when an active pen touches the screen, the operation status of each of the electrodes is shown in FIG. 6. The driving source for each electrode is cut off at this time, and each electrode is only connected with its corresponding detection circuit 25 serving as a receiving end. The active pen 21 will transmit a signal 22 with a certain frequency and amplitude, since there is a mutual-capacitance between the active pen and the electrode, the signal transmitted by the active pen can be coupled to the electrode. The coupled signal can be detected by the detection circuit 25. It should be noted that 22 has been drawn as a square wave with a fixed frequency, however in practice, 22 may be a square wave, a sine wave or other waveforms with a fixed frequency or a variable frequency, and a fixed duty cycle or variable duty cycle. The timing circuit 23 is used to control the detection circuit to be synchronized with the signal 22 transmitted by a capacitive pen.

The difference from a hand is that, the touch area between an active pen and a capacitive screen is usually very small, and generally the diameter is only 1˜2 mm. The mutual-capacitance between the active pen and the electrode is only associated with the distance between the active pen and the electrode. The smaller the distance between the active pen and the electrode is, the bigger the mutual-capacitance is, and bigger the distance between the active pen and the electrode is, the smaller the mutual-capacitance is. Therefore, the amplitude of a pen signal received by each of the electrodes can be considered to be associated with the distance only, the electrode that is closer to the active pen receives a signal with a bigger amplitude, and the electrode that is farther away from the active pen receives a signal with a smaller amplitude. Therefore, the amplitude of the signal received by each of the electrodes can be used to accurately locate the position of the active pen. For example in FIG. 6, the active pen 21 is located between the electrode 19 and the electrode 18, and is the closest to 18, slightly far away from 19, farther away from 17, the amplitudes of signals received respectively by the three electrodes are shown in FIG. 6. Generally, centroid algorithm can be used to obtain the accurate position of the active pen. The amplitude information for only one dimension is simply shown in FIG. 6, however in practice, the sensing amount is two-dimensional information, and accordingly, the calculated coordinates is also two-dimensional information.

Moreover, the signal transmitted by the active pen may include auxiliary information such as pressure and angle, and the information may be modulated in the original signal by frequency or amplitude. After the signal is received by the detection circuit 25, not only the amplitude of the waveform transmitted by the active pen is required to be restored, but also the information in the waveform is required to be resolved. In order to restore the information, the detection circuit 25 is required to be synchronized with the electric signal transmitted by the active pen.

One possible synchronization mechanism is that, the detection circuit is adjusted to be synchronized with an electric signal transmitted by the active touch body by means of a synchronization code transmitted by an active touch body. That is, the detection circuit is adjusted to be synchronized with an electric signal transmitted by the active touch body by means of a synchronization code transmitted by an active touch body. The active pen transmits a segment of synchronization code before each scanning, and the detection circuit is synchronized with the active pen according to the synchronization code.

Another synchronization mechanism is that, the phase of the detection circuit is adjusted by the detection circuit, such that when an amplitude of an electric signal received by the detection circuit is maximum, synchronization with the electric signal transmitted by the active touch body is achieved, and the detection circuit is kept synchronized with the electric signal transmitted by the active touch body under the adjusted phase. That is, the detection circuit adjusts it phase, such that when the amplitude of the received electric signal is maximum, synchronization with the electric signal transmitted by the active touch body is achieved. That is, the detection circuit is made to constantly adjust the phase of the received electric signal according to energy information, and when the amplitude of the received electric signal is maximum, it indicates that the detection circuit is synchronized with the active pen. Of course there are many other methods which can achieve the synchronization. It should be noted that, the synchronization mentioned here is not necessarily needed. If only the position of the pen is needed to be detected and the auxiliary information is not needed to be received, then the synchronization is not required, for example, the amplitude of a signal can be directly restored by the way of quadrature demodulation.

In the embodiments here, it is assumed that the synchronization is required. When only a hand is present on the touch screen, the detection end detects a touch by the hand, and constantly detects whether there is a pen. As shown in FIG. 7, when the hand and the active pen are present simultaneously, the detection end can detect them and achieve synchronization with the signal of the active pen, thereby adjusting the driving timing and receiving timing of the electrode to achieve simultaneous support for the both. At the beginning, there is only touch from the hand, the driving source of the electrode operates at this time, and the detection circuit detects the charge/voltage on the electrode to determine the position of the hand. When the driving for the electrode is completed, the detection circuit may continue operating for a period of time to detect whether there is an active pen. Since the active pen may emit a signal with a specific frequency, this detection can be achieved by measuring the energy at a certain frequency, which is not described in detail here. The driving signal of the active pen can be slightly different from the driving signal of the sensing electrode, for example, having different frequency or different amplitude. Therefore, it is convenient to detect the sensing electrode to determine whether there is an active pen.

As soon as an active pen touches the screen body, the driving signal of the active pen can be detected at this time. However, the driving signal of the active pen is not synchronized with the driving signal of the electrode itself at this time, which may cause the following case: in one frame, the active pen is driven while the electrode is driven, then a certain part of information may be lost or destroyed. Therefore, the synchronization mechanism constantly adjusts the driving timing and receiving timing of the local electrode. This adjustment may be achieved by a constant delay operation or a Phase-Locked Loop (PLL), and the synchronization process may require time of several frames. When the synchronization is achieved, it can be ensured that the driving source of the sensing electrode and the driving source of the active pen will not overlap on time, and that the detection circuit can be synchronized with the driving signal of the active pen, thereby the positions of the hand and the active pen can be completely detected. In embodiments of the invention, each electrode is completely independent in distribution, thereby the synchronization circuit for each electrode is also independent. In order to save resources, it is also possible to use a same synchronization mechanism for several regions.

When there are multiple active pens, since two active pens are unlikely to be placed at one position physically or there is a requirement that two active pens can not be placed too close to be on the same electrode, if the above described scheme that each of the electrodes has an independent synchronization circuit is adopted, then multiple active pens can be supported even the multiple active pens use the same scanning frequency. Particularly, when the positions of two active pens are very close, a certain electrode may simultaneously receive information from the two active pens, and in this case the scanning ways of the two active pens are required to be slightly different from each other, or have different synchronization codes, so that the sensing electrode can distinguish the two pens.

In time, it is required to detect the hand, the active pen 1, the active pen 2 . . . , and the active pen N simultaneously in the same frame. However, the difference from the traditional active pen system is that, by using the active pen system disclosed herein, the time required for the hand detection is very short. As mentioned above, if the touch screen has N driving channels (TX), the time for scanning one frame by an embodiment of the invention is 1/N times of the traditional scanning time in the case where the pen is not considered. As shown in FIG. 8, more time in one frame may be used for scanning and detection and synchronization for a pen. Therefore, the scheme disclosed herein can support more active pens while a frame rate in the embodiments of the invention remains unchanged. Furthermore, the same scanning way or different scanning way can be used between multiple active pens. For example, the same or different scanning frequency can be used, or the same or different duty cycle. This does not affect the implementation scheme of embodiments of the invention.

When there is only one active pen, since the scanning time in the scheme is shorter than the traditional way, the redundant time can also be used to support multiple scans for one active pen. Therefore, multiple frames of data are used to perform signal processing, which can improve the linearity, precision or other indexes of the active pen greatly. Therefore, there can be better performance than a traditional active pen.

Furthermore, since the electrode distribution way of embodiments of the invention is a two-dimensional independent electrode, i.e. each position on the screen corresponds to one electrode, there is no ghost point phenomenon when detecting multiple active pens even though multiple active pens use the same emitting frequency, and the true coordinates of multiple pens can be reflected.

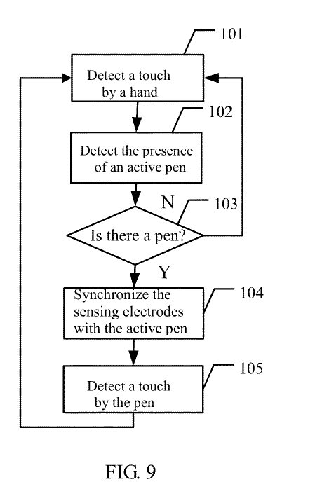

FIG. 9 shows a flowchart of detection in an embodiment of the invention, in which, the preset control scheme requires firstly detecting a touch from a hand and then detecting a touch from an active pen.

Step 101, a hand detection mode is started so as to detect a touch from the hand;

Step 102, then, an active pen detection mode is started so as to detect whether there is a touch from the active pen;

Step 103, whether a touch from the active pen is detected;

Step 104, synchronization of the sensing electrodes with the electric signal of the active pen is performed when a touch from the active pen is detected; and

Step 105, the specific touch position of the active pen is detected.

The description herein enables those skilled in the art to implement or use embodiments of the invention. Numerous modifications to the embodiments will be apparent to those skilled in the art, and the general principle defined herein can be implemented in other embodiments without deviation from the spirit or scope of the disclosure. Therefore, the scope of the present disclosure will not be limited to the embodiments described herein, but encompass the widest scope consistent with the principle and novel features disclosed herein.

What is claimed is:

1. A capacitive touch screen, comprising:
a substrate; a plurality of sensing electrodes provided on the substrate, the plurality of sensing electrodes being arranged in a two-dimensional array; and a touch control chip bound to the substrate, the touch control chip being connected with each of the plurality of sensing electrodes via a corresponding wire, wherein
the touch control chip comprises a driving source, a detection circuit and a timing control circuit, and each of the plurality of sensing electrodes is connected with the driving source and the detection circuit; and
the timing control circuit starts or cuts off the driving source according to a preset control scheme, and the detection circuit detects a change of capacitance of each of the plurality of sensing electrodes to detect a touch position of a touch body on the touch screen.

2. The capacitive touch screen according to claim 1, wherein when the timing control circuit starts the driving source according to the preset control scheme, the detection circuit detects a change of self-capacitance of each of the plurality of sensing electrodes to detect a touch position of a passive touch body on the touch screen.

3. The capacitive touch screen according to claim 1, wherein when the timing control circuit cuts off the driving source according to the preset control scheme, the detection circuit detects a change of mutual-capacitance of each of the plurality of sensing electrodes to detect a touch position of an active touch body on the touch screen.

4. The capacitive touch screen according to claim 1, wherein the timing control circuit controls the driving source to start the plurality of sensing electrodes simultaneously or group by group, so that the detection circuit detects the plurality of sensing electrodes simultaneously or group by group.

5. The capacitive touch screen according to claim 2, wherein the timing control circuit controls the driving source to start the plurality of sensing electrodes simultaneously or group by group, so that the detection circuit detects the plurality of sensing electrodes simultaneously or group by group.

6. The capacitive touch screen according to claim 3, wherein the timing control circuit controls the driving source to start the plurality of sensing electrodes simultaneously or group by group, so that the detection circuit detects the plurality of sensing electrodes simultaneously or group by group.

7. The capacitive touch screen according to claim 1, wherein the detection circuit is not synchronized with an electric signal transmitted by an active touch body.

8. The capacitive touch screen according to claim 2, wherein the detection circuit is not synchronized with an electric signal transmitted by an active touch body.

9. The capacitive touch screen according to claim 3, wherein the detection circuit is not synchronized with an electric signal transmitted by the active touch body.

10. The capacitive touch screen according to claim 1, wherein the detection circuit is kept synchronized with an electric signal transmitted by an active touch body.

11. The capacitive touch screen according to claim 2, wherein the detection circuit is kept synchronized with an electric signal transmitted by an active touch body.

12. The capacitive touch screen according to claim 3, wherein the detection circuit is kept synchronized with an electric signal transmitted by the active touch body.

13. The capacitive touch screen according to claim 10, wherein the detection circuit is adjusted to be synchronized with an electric signal transmitted by the active touch body by means of a synchronization code transmitted by the active touch body.

14. The capacitive touch screen according to claim 10, wherein the detection circuit adjusts its phase, so that when an amplitude of an electric signal received by the detection circuit is maximum, synchronization with the electric signal transmitted by the active touch body is achieved, and the detection circuit is kept synchronized with the electric signal transmitted by the active touch body under the adjusted phase.

15. The capacitive touch screen according to claim 1, wherein each sensing electrode has at least one driving frequency.

16. The capacitive touch screen according to claim 2, wherein each sensing electrode has at least one driving frequency.

17. The capacitive touch screen according to claim 1, wherein the plurality of sensing electrodes belong to at least more than one sensing electrode region, and the number of the touch control chips is the same as the number of the sensing electrode regions, and each touch control chip is connected with each sensing electrode in the sensing electrode region under control of the touch control chip via a wire.

18. The capacitive touch screen according to claim 17, wherein the clocks of the touch control chips are synchronous or asynchronous.

19. The capacitive touch screen according to claim 1, wherein the sensing electrode is in a shape of at least one of a rectangle, a diamond, a circle and an ellipse.

20. The capacitive touch screen according to claim 1, wherein
the substrate is a glass substrate, and the touch control chip is bound to the substrate in a chip-on-glass way; or
the substrate is a flexible substrate, and the touch control chip is bound to the substrate in a chip-on-film way; or
the substrate is a printed circuit board, and the touch control chip is bound to the substrate in a chip-on-board way.
